(19) United States
(12) Patent Application Publication
(10) Pub. No.: US 2008/0181777 A1
(43) Pub. Date: Jul. 31, 2008

(54) Turbine with desirable features

(76) Inventor: James Robert Bailey, (US)

Correspondence Address: John William Sparks, Suite 116, 1350 Nasa Parkway, Houston, TX, 77058, US

(21) Appl. No.: 11/698,366

(22) Filed: Jan. 26, 2007

(51) Int. Cl. F03D 3/02; F03D 3/06; F03D 9/00; F01D 15/10; B65D 69/00

(52) U.S. Cl. 416/117; 416/120; 416/131; 290/52; 206/223

(57) ABSTRACT

A power generating turbine is disclosed having a vertical axis, a generator connected to the vertical axis, and coupled blades connected to the vertical axis. The coupled blades are a horizontal axis; one or more blades, comprising a first set of blades, attached near one end of the horizontal axis; and one or more blades, comprising a second set of blades, attached near the opposing end of the horizontal axis wherein the broad sides of the second set of blades are orthogonal to the broad sides of the first set of blades, the broad sides of the blades are parallel to the horizontal axis, and the blades pivot on a vertical path. The middle portion of the horizontal axis is pivotably connected to the vertical axis. Solar cells can be attached to various parts of a turbine for generating power.

### FIELD OF INVENTION

The invention relates to power generation, particularly wind power, water power, and solar power.

### BACKGROUND OF THE INVENTION

The use of wind as a power source is well known. Sailing vessels and windmills have captured the power of the wind for over five centuries. It is not surprising that many countries, when faced with higher oil prices and occasionally interrupted supplies of oil, have sought to use this power, especially for generating electrical power.

Electrical power generators are increasingly turning to wind as a power source. While most of the economic factors driving this conversion are government related, it would not take but a few years of higher crude oil prices or reduced supplies for there to be many more wind power generators being constructed. Most of the power generation from the wind is being captured on large wind farms.

These wind farms primarily use modified windmills to generate power. These modified windmills are technically enhanced and very large in design. These windmills use blades over fifteen feet long, the rotors may be positioned over one hundred feet above the ground, and the generators are industrial size. These industrial sized windmills are expensive to build and require wind speeds in excess of fifteen miles per hour just to get the blades turning.

These large windmills generally require wind speeds between forty and sixty miles per hour to make them economically feasible. To get these wind speeds and to get reliable winds, the rotors have to be placed very high above the ground. Optimal operation of these wind farms requires them to be placed on land without nearby obstructions, meaning no population centers, no trees, and no buildings.

The power generating companies, businesses, and even homeowners see the great upfront construction expense, the inefficiency at low wind speeds, and the unobstructed landscape as significantly limiting their use of large windmills. These prospective operators of wind energy systems want low construction costs, power generation at low wind speeds, generating facilities that can be placed anywhere, and efficient power generation over broader ranges of wind speeds.

These prospective operators of wind energy systems are increasing examining small wind turbines as devices capable of meeting their needs, particularly vertical axis wind turbines. These wind turbines are much less expensive to build; generate power at low wind speeds; can be placed in more locations; can perform under all wind conditions, steady or turbulent; and can operate in all wind directions without the need for a steering mechanism. While there are several different types of these small wind turbines, the inventor thought of a low drag wind turbine.

A turbine can also be equipped with solar cells attached to the various parts of a turbine for generating power, whether the turbine is capturing power from other sources or not capturing power from other sources.

This turbine has few moving parts; has low drag for better power generating efficiency; is capable of operating at wind speeds above five miles per hour; can be used near populated areas, trees, and buildings; can be positioned on buildings and other structures; is omni-directional; is low maintenance; and it has no need for steering control mechanisms.

### SUMMARY

This turbine has certain desirable features. A desirable feature is coupled blades connected to a vertical axis wind turbine. Another desirable feature is solar cells being attached to various parts of a turbine for generating power.

Some embodiments of the invention may also have a means of restricting the pivoting of the coupled blades, impact springs, or cushions. Some embodiments of the invention have coupled blades and these blades have an airfoil profile. These desirable features on an embodiment create an efficient and low drag turbine that is omni-directional, has low maintenance, functions at low wind speeds, and has no need for steering control mechanisms.

Some embodiments of the invention have a vertical axis, one or more horizontal axes that are pivotably connected to the vertical axis, and blades that are attached near each end of the horizontal axis, the blades are parallel to the horizontal axis, the blades on one end of the horizontal axis are positioned orthogonal to the blades on the opposing end of the horizontal axis, and the blades pivot on a vertical path. The horizontal axes of some embodiments are pivotable horizontal members.

Some embodiments of the invention have coupled blades connected to a vertical axis. These coupled blades have a horizontal axis; one or more blades, comprising a first set of blades, attached near one end of the horizontal axis; and one or more blades, comprising a second set of blades, attached near the opposing end of the horizontal axis, wherein the blades are parallel to the horizontal axis, the blades pivot on a vertical path, and the second set of blades are positioned orthogonal to the first set of blades. It is preferable that the second set of blades be positioned orthogonal to the first set of blades with the same direction of orthogonal attachment.

The blades have a broad side and an airfoil profile. The airfoil profile has a forward portion that is generally rounded and a trailing portion that tapers to an edge. This airfoil profile of the blades is preferably continuous across the entire length of the broad side of the blade.

The forward portion of the blade is attached to a horizontal axis on a turbine. The trailing portion of the blade pivots on a vertical path. The coupled blades pivot on the same horizontal axis. When the coupled blades are viewed from the end of their horizontal axis, the airfoil profile of the blades can be seen.

The airfoil profile of the blades may have many different aerodynamic shapes. Some embodiments have airfoil profiles that have aerodynamic lift. Some embodiments have airfoil profiles that are symmetrical. Some embodiments have airfoil profiles that are narrow in thickness. It is desirable that the airfoil profiles be narrow in thickness, as a narrow airfoil profile has less drag.

There is a set of coupled blades on each horizontal axis. An embodiment may have many horizontal axes. In some embodiments, one or more blades of the coupled blades will be on one side of the vertical axis and the opposing one or more blades of the coupled blades will be on the opposing side of the vertical axis.

The horizontal axes of an embodiment may be disposed in a vertically aligned arrangement about the vertical axis. The horizontal axes of an embodiment may be disposed in many different horizontal directions. The horizontal axes of an embodiment may be disposed away from the vertical axis or the horizontal axes may be disposed near the vertical axis. With multiple horizontal axes, there can be many coupled blades on an embodiment.

In a preferred embodiment, there are many coupled blades, comprising a first group of coupled blades and a second group of coupled blades, with the first group of coupled blades disposed in a vertically aligned arrangement near the vertical axis with their horizontal axes parallel to each other and the second group of coupled blades disposed in a vertically aligned arrangement near the vertical axis with their horizontal axes disposed orthogonal to the first group of coupled blades. Embodiments having two or more groups of coupled blades disposed horizontally at vastly different angles will be omni-directional.

There are many different possible means of restricting the pivoting of the coupled blades. Pivot stops are some of the various means of restricting the pivoting of the coupled blades. Pivot stops are structural features that prevent the coupled blades from pivoting into undesirable orientations.

It is desirable to install the different means of restricting the pivoting of the coupled blades within the features of the embodiment so that the different means do not increase the drag of the embodiment. These pivot stops may have many different configurations. The pivot stops may also be used to prevent nearby blades from impacting each other. Such blade impacts may create excessive noise.

The pivot restriction means can be breaking systems; structural features between the moving parts to prevent undesirable pivoting; locking systems with structural features, where the locking system adjusts the position of the structural features and the structural features prevent undesirable pivoting so the positioning of the blades may be adjusted; and the interacting parts may be manufactured to only allow a certain range of motion for the blades. There are many different means of restricting the pivoting of the coupled blades. In some embodiments, the pivot restriction means are optional.

The impact springs are springs that lessen blade impacts or impacts between nearby parts. These impact springs may have many different configurations. It is desirable to install the impact springs within the features of the embodiment so that the springs do not increase the drag of the embodiment. The impact springs are an optional feature.

Cushions may be installed to lessen blade impacts or impacts between nearby parts. These cushions may be made of a shock absorbing material. It is desirable to install the cushions within the features of the embodiment so that the cushions do not increase the drag of the embodiment. The optional cushions, optional impact springs, is and pivot restriction means can be integrated.

It is preferable for this integration to occupy the space between the orifice of the rotary shaft and the horizontal member that occupies the orifice of the rotary shaft. This causes the impact springs, cushions, and pivot restriction means to create less drag.

The coupled blades pivot in response to the external forces being applied to the blades. The two main forces being applied to the coupled blades are gravity and wind. The force of gravity is constant and is being applied to both of the coupled blades simultaneously.

The force of the wind varies in strength and direction. When there is no wind being applied to the blades, the force of gravity is the main force acting on the coupled blades. When there is no wind being applied to the blades, the blades are in a resting state. In an embodiment having solar cells attached to the turbine, the turbine can generate power on sunny days even when there is no wind.

When there is wind, the coupled blades respond to the forces being applied to the blade. The wind will cause the coupled blades in certain positions to pivot. The result of the pivoting is that more force from the wind will be applied to some of the blades. The difference between the applied wind forces between the blades of the coupled blades determines the direction of rotation of the embodiment about the vertical axis.

The rotation of the vertical axis of the embodiment rotates the generator connected to the vertical axis and produces energy. An embodiment may be connected to a power consuming device, rather than a power generating device. This will allow the turbine to power a device directly.

These and other features, aspects, and advantages of the present invention will become better understood with regard to the following description, appended claims, and accompanying drawings where:

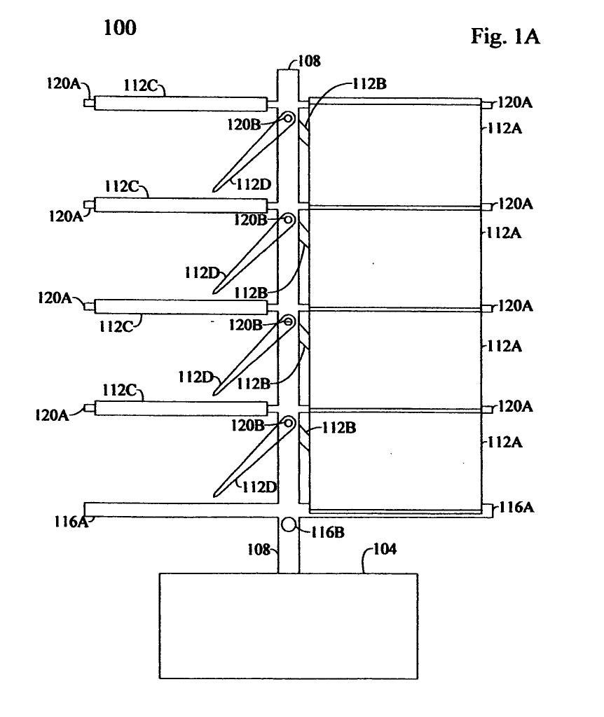

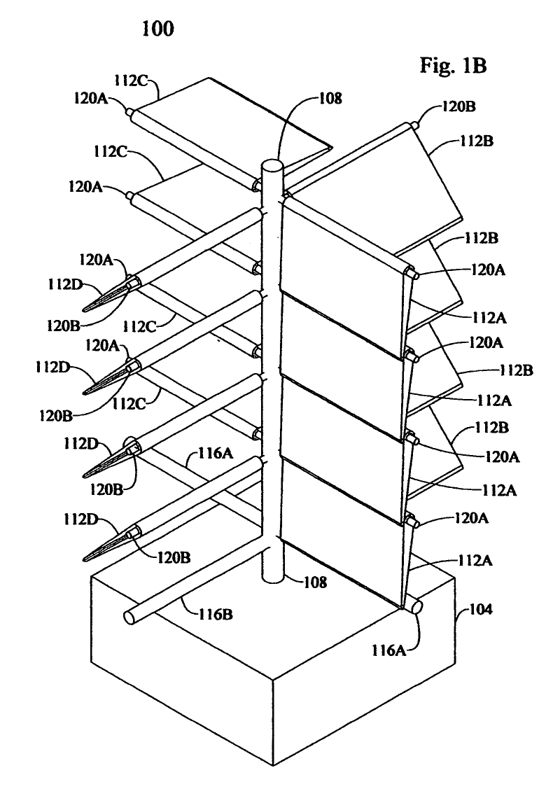

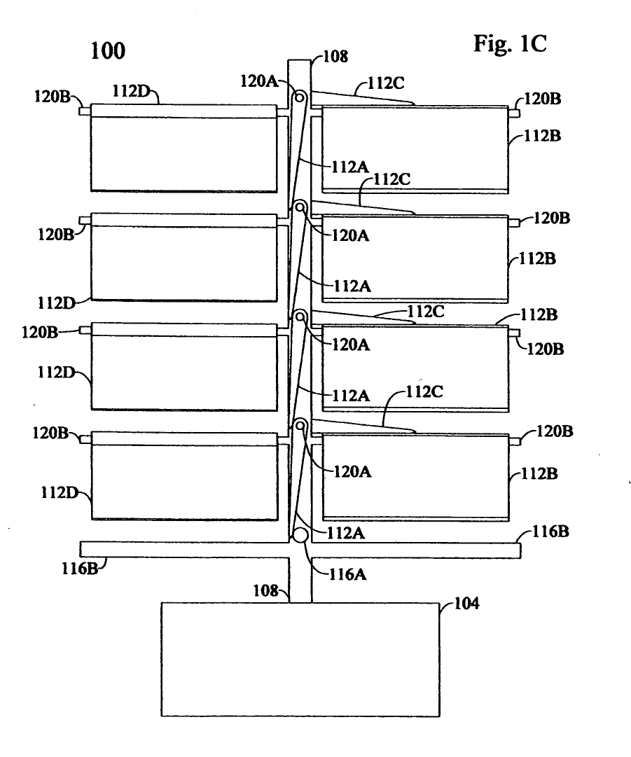

FIG. 1A depicts an upwind view of embodiment 100 of the invention,

FIG. 1B depicts an isometric view of embodiment 100 of the invention,

FIG. 1C depicts a right side view of embodiment 100 of the invention,

FIG. 1D depicts a top view of embodiment 100 of the invention,

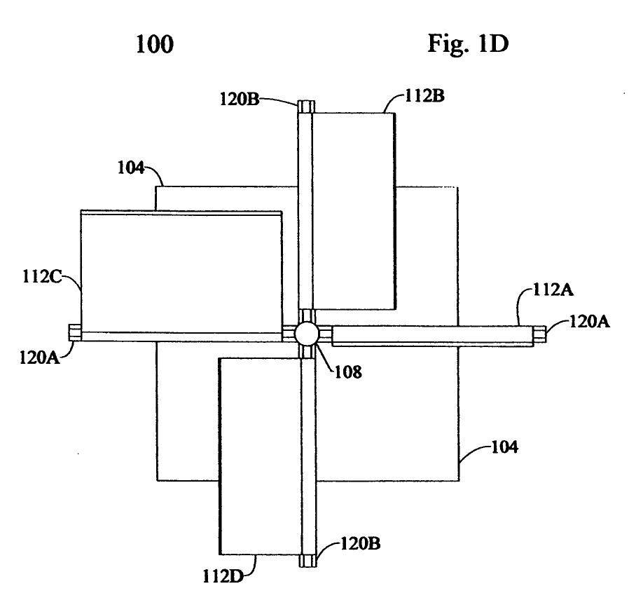

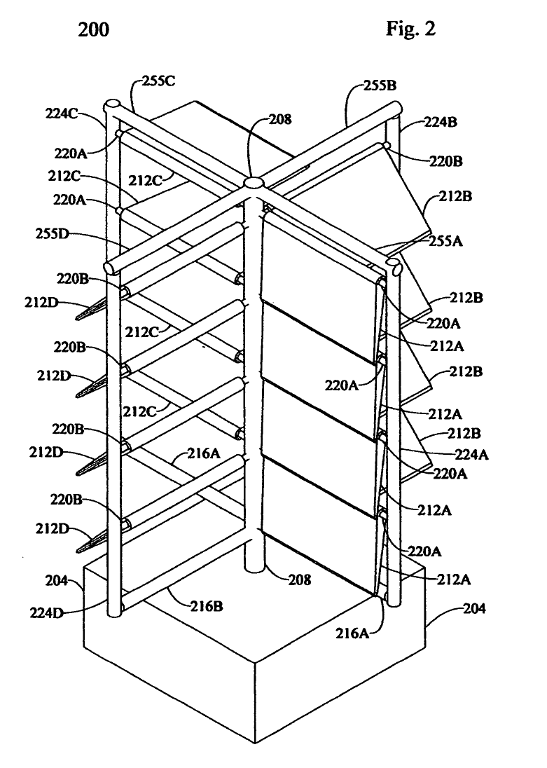

FIG. 2 depicts an isometric view of embodiment 200 of the invention, and

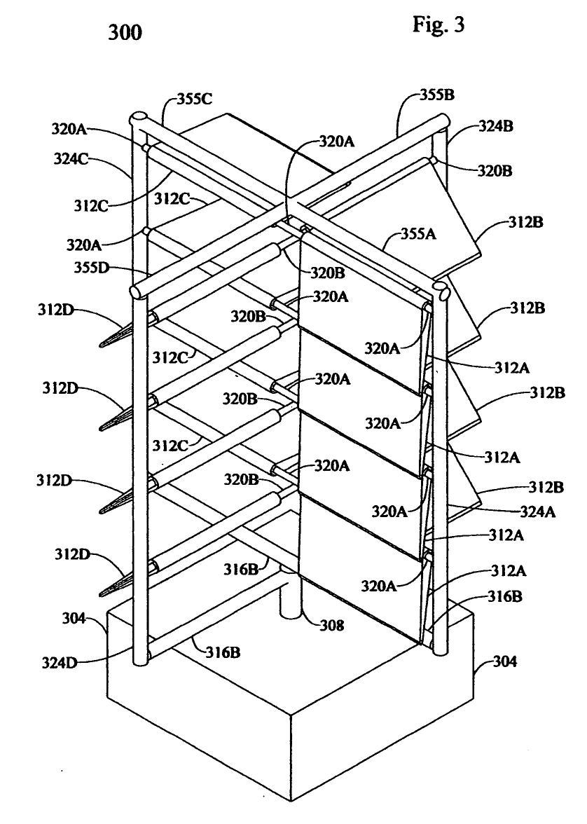

FIG. 3 depicts an isometric view of embodiment 300 of the invention.

### DETAILED DESCRIPTION

In accordance with some embodiments described herein, a power generating turbine is disclosed having a vertical axis; a generator connected to the vertical axis; one or more horizontal axes pivotably connected to the vertical axis; one or more blades that are attached near each end of the horizontal axis, wherein the blades are parallel to the horizontal axis, the blades on one end of the horizontal axis are attached orthogonal to the attachment of the blades on the opposing end of the horizontal axis, and the blades pivot on a vertical path; an optional means for restricting the pivoting of the coupled blades; optional impact springs; and optional cushions. Solar cells attached to various parts of a turbine are also disclosed and claimed.

Some embodiments have coupled blades. A coupled blade has a horizontal axis; one or more blades, comprising a first set of blades, attached near one end of the horizontal axis; and one or more blades, comprising a second set of blades attached near the opposing end of the horizontal axis, wherein the broad sides of the second set of blades is orthogonal to the broad sides of the first set of blades, the broad sides of the blades are parallel to the horizontal axis, and the blades pivot on a vertical path. It is preferable for the coupled blades of a particular embodiment to have the same direction of orthogonal attachment to the horizontal axes. It is preferable that the blades be alike having the same size, mass, composition, and density.

The blades have a broad side and an airfoil profile. The blades, in one direction, resemble an airfoil, having a forward portion that is generally rounded and a trailing portion that tapers to an edge. It is preferable for this airfoil profile of the blade to be continuous across the entire length of the broad side of the blade. It is preferable for the airfoil profile to have a narrow thickness.

The forward portion of the blade is attached to a horizontal axis on an embodiment. The trailing portion of the blade pivots on a vertical path. The coupled blades pivot on the same horizontal axis. When the coupled blades are viewed from the end of their horizontal axis, the airfoil profile of the blades can be seen.

There are two or more blades coupled on each horizontal axis. An embodiment may have many horizontal axes. The first set of blades of the coupled blades will be on one end of the horizontal axis and the second set of blades of the coupled blades will be on the opposing end of the horizontal axis. The horizontal axes may be disposed away from the vertical axis or near the vertical axis.

A preferred embodiment of the invention has the horizontal axes of coupled blades disposed in a vertically aligned arrangement near the vertical axis wherein the horizontal axes are parallel to each other and the horizontal axes are approximately one blade width apart. In this arrangement, the blades overlap, abut, or almost abut with the vertically adjacent blades of other coupled blades. This arrangement allows very little wind to go between the blades.

If the horizontal axes of this arrangement are positioned correctly, the blades will restrict the pivoting of the vertically adjacent blades that are above their position. In this arrangement, the blades comprise a means of restricting the pivoting of the coupled blades that are vertically adjacent and above their position.

A preferred embodiment has a first group of coupled blades disposed in one direction and a second group of coupled blades disposed in another direction that is at a vastly different angle, such as orthogonal, to the direction of the first group of coupled blades. This arrangement allows the turbine to be omni-directional so it can capture power from any wind direction that is horizontal to the vertical axis.

Applicant's preferred embodiment was specifically designed for generating power from the wind. Some embodiment may be able to generate power from other moving fluid sources, particularly tides and waves. The desirable blades for wind power generation would be made of a durable polymer, composite, or light metallic alloys, even possibly hollow inside the blades. These lightweight blades may be buoyant in an aqueous environment.

Buoyant blades in an aqueous environment would not respond to the force of gravity. The blades pivot into actionable positions in part due to gravity. Buoyant blades might not pivot properly when exposed to a weak horizontal flow, thus causing the turbine to possibly malfunction in an aqueous environment.

For embodiments designed to function in aqueous environments, it is preferable for the blades to be denser than water so gravity can facilitate pivoting of the blades into actionable positions for functioning. The desirable blades for aqueous power generation would be denser than water and made of durable polymer, composite, or light non-corrosive metallic alloys.

Many of the embodiments of the invention have no front, back, right side, or left side. For purposes of description, the “front” refers to that portion of the embodiment that is upwind of the other elements of the embodiment. Therefore, the front is relative to the direction of the wind. The positioning of the blades is relative to the applied forces.

The “back” or “rear” refers to the side or part of the embodiment away from the front. “Forward” or “frontward” refers to a position toward the front of the embodiment. “Backwards” or “rearward” refers to a position toward the back of the embodiment. “Right” refers to the right side of the embodiment when the observer is facing the front of the embodiment.

“Left” refers to the side of the embodiment away from the right. “Frame” refers to any frame of a structure or supporting structure. A “member,” “support member,” or “support bar” is any member whether a part of the frame or a supporting member attached to the frame. “Top” refers to that portion of the embodiment that is away from the ground. “Bottom” refers to that portion of the embodiment that is near the ground.

“Downward vertical position” is where the broad side of a blade is in a vertical position and the blade is in its lowest possible rotational position. “45 degrees downward” is where the broad side of the blade is at a 45 degree angle to a downward vertical position. A “turbine” is any structure that is a turbine, houses a turbine, supports a turbine, is connected to a turbine, or is part of a turbine.

A “vertical axis” is an axis that is disposed vertically. A “horizontal axis” is any axis that is disposed horizontally or nonvertically. A “vertical member” is a member that is disposed vertically. A “perimeter frame” is any frame or member that connects the ends of the various elements of an embodiment that are away from the vertical axis.

A “rotary member” is any member capable of rotating. “Pivotable members” are any members capable of pivoting. The term “orthogonal” means orthogonal, at a right angle, or any angle near orthogonal. Omni-directional is a device that is capable of functioning from many directions, particularly many horizontal directions.

The horizontal axes can be pivotable horizontal members. A rotary shaft is a member capable of rotating. The rotary shaft is a vertical axis.

In conventional usage, in the aeronautics industry, an airfoil profile is the contour of a wing, particularly a cross section of a wing, capable of flight when attached to a propulsion vessel. The blades do not have to have an airfoil profile, to function, but it is a desirable shape for decreasing drag and creating lift. The term “airfoil profile,” as used in the description and claims, refers to the contour of the blades as having a narrow thickness or an airfoil profile.

A desirable orientation of the blades is any orientation of the blades that achieves the objectives of capturing the wind, decreasing drag, or creating desirable lift. An undesirable orientation of the blades is any orientation of the blades that causes a malfunction or makes parts of the embodiments unusable.

A “pivot restriction means” is any means of restricting or halting the pivoting of the coupled blades. A “means of restricting the pivoting” is any means of restricting or halting the pivoting of the coupled blades. For optimal functioning of some embodiments, it is desirable to halt the pivoting of the couple blades at desirable orientations for capturing the wind.

In this description and claims, the “set” of blades and the “group” of coupled blades are not synonymous. The “set” of blades should not be treated as synonymous with the “group” of coupled blades in this application.

A preferred embodiment of the invention has the horizontal axes of a first group of coupled blades parallel to each other and disposed in a vertically aligned arrangement and has the horizontal axes of a second group of coupled blades parallel to each other within the second group, has the horizontal axes of the second group of coupled blades disposed in a vertically aligned arrangement, and has the horizontal axes of the second group of coupled blades orthogonally disposed relative to the horizontal axes of the first group of coupled blades, wherein any two adjacent horizontal axes of the same group have a horizontal axis of the other group disposed between the two adjacent horizontal axes of the same group.

In this arrangement, the blades can be positioned to contact or almost contact the blades that are vertically adjacent to them on the vertical axis. The blades will respond to wind from any horizontal direction. This allows very little wind to go between the blades when the broad sides of the blades are vertical. This preferred embodiment is omni-directional, has low drag, and is more efficient than other vertical axis turbines.

The blades of an embodiment have two forces acting on them, the force of gravity and the force of the wind. The force of gravity is a continuous downward force. The wind is generally a horizontal force. The force of the wind affects the coupled blades when their horizontal axis is not parallel to the wind direction.

When there is no wind, the force of gravity is the main force acting on the coupled blades. When there is no wind, the blades are in a resting state. In a resting state, when the coupled blades are viewed from the end of their horizontal axis, the blades will be positioned 45 degrees downward, as gravity is simultaneously affecting the opposing blades. When viewed from the end of the horizontal axis, one blade of the coupled blades will be 45 degrees downward to the right and the opposing blade of the coupled blades will be 45 degrees downward to the left, thus still maintaining the orthogonal positioning of the blades relative to each other.

As gravity is simultaneously affecting the coupled blades and the blades will have the same approximate mass, the affect of gravity upon the blades will be more significant when the horizontal axis is nearly parallel to the wind direction or there is little or no wind. When there is significant wind speed, the wind will be a stronger force acting on the blades than gravity.

When there is wind acting on the blades, then the forces of gravity and wind determine the position of the blades. The forces of gravity and wind are in different directions and acting on pivotable blades. While the force of gravity is constant, the affect of the wind is changing in magnitude and direction while the turbine is rotating about a vertical axis. The changing applied forces cause the pivotable blades to pivot on their horizontal axes, while the turbine is rotating about the vertical axis.

The blades of the coupled blades are connected and experience the affects of the forces simultaneously. The coupled blades are orthogonally positioned relative to each other so the affects of the forces are different for each blade. When there is enough wind to activate the wind turbine, the wind will push one blade causing it to pivot downward and simultaneously push the opposing blade causing it to pivot upward. The coupling arrangement of the coupled blades causes the blades to pivot correctly in response to the changing forces.

Pivot restriction means should halt the pivoting of the blades when the broad sides of one set of blades on one end of the horizontal axes are in a nearly vertical position. A pivot restriction means can be an element that obstructs the motion of the blades when the blades attain a vertical position. A pivot restriction means can be a breaking system that halts the pivoting of the blades.

A pivot restriction means can be a locking system connected to a pivot restriction means, where the locking system adjusts the positioning of the pivot restriction means and the pivot restriction means halts the blades at the adjusted desired position. A pivot restriction means can be manufactured into the interacting parts of the turbine so that the interacting parts will only allow pivoting within a certain range of motion.

Some pivot restriction means will be structural features on the rotary shaft that interact with the features on the horizontal members to prevent further pivoting of the blades. Some pivot restriction means will be structural features on the horizontal members that interact with the features on the rotary shaft to prevent further pivoting of the blades. Some pivot restriction means can be attached to the perimeter frame to interact with blades.

Some pivot restriction means are structural features on the frame that interact with features of the horizontal members or nonvertical members to prevent further pivoting of the blades. Some pivot restriction means are structural features on the horizontal members or nonvertical members that interact with features of the frame to prevent further pivoting of the blades.

Some embodiments of the invention have pivot stops. The pivot stops are a means of restricting the pivoting actions of the coupled blades. Pivot stops are structural features that prevent the blades from pivoting into undesirable orientations.

There are many conceivable means of stopping the motion of the coupled blades. Some pivot stops will be horizontal members that physically obstruct the motion of the coupled blades. Some pivot stops will be attached to the horizontal members that pivot so that the pivot stops engage features on the rotary shaft to prevent further pivoting.

Some pivot stops will be structural features on the rotary shaft that interact with the features on the horizontal members to prevent further pivoting of the blades. Some pivot stops will be structural features on the horizontal members that interact with the features on the rotary shaft to prevent further pivoting of the blades. Some pivot stops can be attached to the perimeter frame to interact with blades.

The pivot stops may also be used to prevent adjacent blades from impacting each other. Such blade impacts may create excessive noise. Cushions are shock absorbing materials. Cushions associated with the pivot stops may prevent excessive noise. Cushions between the impacting elements may prevent excessive noise.

Impact springs can be used to decrease the impact of the blades from hitting each other or from hitting the pivots stops. The impact springs may be placed in many positions to function properly. The impact springs could lower the noise being produced during operation of the wind turbine. A desirable place to place the impact springs is within the orifices of the rotary shaft of the turbine so the impact springs have no wind resistance. Another desirable position for the impact springs is to associate the impact springs with the pivot restriction means.

The pivot restriction means prevents the coupled blades from pivoting significantly more than 90 degrees. This control of the pivoting of the coupled blades determines how the blades position themselves in the wind. The positioning of the coupled blades determines the direction of rotation of the vertical axis. It is desirable that the pivot restriction means halts the blades on one end of the horizontal axis at a vertical downward position.

As the horizontal axes are rotating around the vertical axis, the force of gravity and the changing force of the wind act on the blades to cause a pivoting action. This pivoting action of the blades correctly positions the blades to capture the wind power on one side of the vertical axis of the turbine while the same pivoting action correctly positions the blades to decrease drag on the opposing side of the vertical axis of the turbine.

It is desirable to manufacture many of the components of the turbine from strong, lightweight materials. The blades may be made of polymers, composites, aluminum alloys, or magnesium alloys. The members, shaft, and frame of the turbine may be made of metallic alloys that resist the damaging effects of the environment.

A frame can be placed around an embodiment of the turbine to provide additional structural support to various elements or to the whole structure of the turbine. The frame is a member or series of members that extend vertically from the bottom of the turbine, encompass the ends of the horizontal members, and may turn horizontally toward the vertical axis. At specific sites along the frame, the frame would have horizontal orifices for receiving the ends of the horizontal members. The horizontal orifices of the frame could be lined with a low friction coating, such as a polymer of tetrafluoroethane, to allow the horizontal members to pivot with very little friction inside the horizontal orifices of the frame.

The airfoil feature of the blades makes the blades aerodynamic in a first direction of use, where the broad side of the blades is horizontal to the wind, so they have little drag and can have aerodynamic lift. In a second direction of use, the broad side of the blade is normal to the wind resulting in the greatest drag force across the surface of the broad side of the blade. This increased drag force causes these blades to be pushed by the wind while the opposing blades, that are horizontal, slice through the wind with little drag. When there is no wind, the coupled blades will be in a resting state.

If the horizontal axes of the coupled blades are far apart on the vertical axis, the embodiment has lower drag than a turbine with horizontal axes of the coupled blades closer together as each additional horizontal axis incrementally increases the drag on the turbine. As with any optimization, other factors may make it desirable to not space the horizontal axes to far apart on the vertical axis of the wind turbine.

If the blades are designed with some aerodynamic lift then the blades would reach the desirable positions quicker thus decreasing the overall drag and increasing the effectiveness of capturing the power of the available wind. The efficiency of the wind turbine can be increased by making the blades with very little drag when the blades are in the horizontal orientation.

The blades can be made with aerodynamic lift and low drag by using aerodynamic equations to determine the shape of the blades. Since wind speeds seldom exceed 60 miles per hour for wind turbines, the blades of a wind turbine do not require the fine aerodynamic profiles of performance aircraft and fighter jets. The blades should be manufactured for low drag with a small amount of lift to get correctly shaped blades that perform efficiently for the particular application.

A desirable result of the coupled aerodynamic blades is greater power generation from the wind at a greater range of wind speeds, particularly at low wind speeds. While it is well established that higher wind speeds generate exponentially more power than lower wind speeds, being able to generate power at low wind speeds is better than no power generation at all. Vertical axis wind turbines can generate power at both high and low wind speeds and they do not require elevated structures to function economically.

When the various embodiments of the invention are functioning, most of the elements of an embodiment are in motion. Many of these movements of the various elements of an embodiment are occurring simultaneously during a complex repetitious pattern. In each rotation of an embodiment about a vertical axis, the elements attain various positions in relation to the directions of the driving forces upon the embodiments.

The appended figures depict how an embodiment might appear at particular instances during each rotation. Each view, therefore, only exists in relation to the direction of the driving force and how the blades were installed on the embodiment. If the blades were coupled orthogonally in reverse of how the blades are shown, then a mirror image of each depiction would be seen.

When viewing the various embodiments depicted in the figures, the direction of the wind will be orthogonal to the broad side of the blades that are in a vertical position, as the wind pushes the blades into the vertical position.

In FIG. 1A, a “front” view of an embodiment 100 of the invention is depicted. The embodiment 100 is omni-directional and technically has no front or side. The “front” of this embodiment is only relevant to the direction of the driving force upon the embodiment. The wind is the driving force and the wind is parallel to the direction of viewing.

The embodiment 100 has a vertical axis; a generator (not shown) connected to the vertical axis; one or more horizontal axes disposed along the vertical axis; one or more blades that are attached near each end of the horizontal axis wherein one or more blades are disposed on each side of the vertical axis, the blades are parallel to the horizontal axis, the blades are attached orthogonally relative to each other, and the blades pivot on a vertical path, wherein the blades coupled to a horizontal axis constitutes a coupled blade; and a means for restricting the pivoting of the coupled blades.

This is how the embodiment would appear if the prevailing driving force came from the direction of viewing and the orthogonal attachment of the coupled blades were as depicted in the figure. The direction of the rotation of the embodiment 100 about the vertical axis would be counterclockwise when viewed from the top if the orthogonal attachment of the coupled blades were as depicted in the figure and the wind was parallel with the horizontal members 120B and coming from the direction of viewing.

FIG. 1A is a depiction of embodiment 100 at a particular instance during the rotation of the embodiment about the vertical axis. FIGS. 1A, 1B, 1C, and 1D show the same embodiment 100 having the same wind direction from different views. The description of the elements and their function as applied to FIGS. 1B, 1C, and 1D apply to this description of FIG. 1A.

The generator housing 104 is at the base of the embodiment. The generator housing 104 contains a generator (not shown) and any gears (not shown) needed for transferring a rotational force to the generator. The generator housing 104 is depicted as a broad structure to provide a solid base for the embodiment.

The rotary shaft 108 is a vertical and central shaft that rotates on a vertical axis. The rotary shaft 108 constitutes a vertical axis. The rotary shaft has several horizontal orifices (not shown) that extend through the shaft. The horizontal orifices are either orthogonal or parallel to each other in this embodiment. On the lower end of the rotary shaft 108 is a gear (not shown). The rotary shaft 108 is connected to the generator (not shown) within the generator housing 104 through a series of gears (not shown). The rotary shaft 108 drives the generator (not shown) within the generator housing.

The coupled blades (not individually labeled) are horizontally disposed along the vertical length of the rotary shaft 108. The coupled blades comprise a horizontal member (120A or 120B, collectively 120) and two blades (112A, 112B, 112C, or 112D, collectively 112). The horizontal member constitutes a horizontal axis.

The horizontal members 120 extend through the horizontal orifices of the rotary shaft 108. The inside of the horizontal orifices of the rotary shaft 108 may be lined with a frictionless surface (not shown). The horizontal members 120A pivot on a horizontal axis within the horizontal orifices of the rotary shaft.

The middle portion of the horizontal members 120 occupy the horizontal orifices of the rotary shaft 108, while the end portions of the horizontal members 120 are disposed on either side of the rotary shaft 108. The horizontal members 120A extend laterally. The horizontal members 120B are shown from an end view as the horizontal members 120B occupy the horizontal orifices of the rotary shaft 108 that are nearly parallel with the view.

The horizontal members 120A are parallel to each other. The horizontal members 120B are parallel to each other. The horizontal members 120B are orthogonally disposed relative to the horizontal members 120A.

The disposition of the horizontal members 120A and 120B alternate along the length of the rotary shaft 108. The horizontal members 120A are closer to the adjacent horizontal members 120B than to the adjacent horizontal members 120A. The horizontal members 120B are closer to the adjacent horizontal members 120A than to the adjacent horizontal members 120B.

Near each end of the horizontal member (120A or 120B) is a blade (112A, 112B, 112C, or 112D). The blades 112A and 112C are attached to horizontal members 120A. The blades 112 have a broad side and a narrow airfoil profile.

The broad side of the blades 112 can be seen by looking at the blades 112A. The broad sides of the blades 112 are parallel with the length of the associated horizontal member and pivot on a vertical path. The narrow airfoil profile of the blades 112 can be seen by looking at blades 112D, as these blades are shown from an end view. The narrow airfoil profile is continuous along the entire length of the broad side.

The blades 112 have a front portion and a trailing portion. The front portions of the blades 112 are attached to the horizontal members 120 and the trailing portion pivots with the front portion. As shown, the blades 112 extend to partially overlap with the adjacent blades that are under them. This overlap is depicted by viewing the blades 112A, as the blades 112A are nearly vertical. This overlap can be better seen by viewing the blades 112A of FIGS. 1B and 1C.

The blades 112B (partially shown) and 112D (shown from an end view) are attached to horizontal members 120B (shown from an end view). In this depiction, the blades 112A are disposed on the right side of the rotary shaft 108, the blades 112C are disposed on the left side of the rotary shaft, the blades 112D are disposed near the foreground in front of the rotary shaft 108, and the blades 112B (partially hidden) are disposed behind the rotary shaft.

The coupled blades pivot freely as a unit. The blades 112A pivot simultaneously with the blades 112C, as these blades are coupled. The blades 112B pivot simultaneously with the blades 112D, as these blades are coupled. The blades 112A and 112C pivot independently of the blades 112B and 112D. The blades 112B and 112D pivot independently of the blades 112A and 112C. The coupled blades pivot in response to the forces exerted upon them.

The blades 112A and 112C are attached to the horizontal member 120A. The blades 112B and 112D are attached to the horizontal member 120B. The broad sides of the blades 112A and 112C are attached orthogonal to each other. The broad sides of the blades 112B and 112D are attached orthogonal to each other. The blades of the coupled blades are orthogonal to each other.

This orthogonal attachment of the blades to the horizontal members can be seen by looking at the coupled blades from an end view. In FIG. 1A, the blades 112B (partially visible) and the blades 112D are shown orthogonally attached to the horizontal member 120B (end view). For proper functioning, the coupled blades of an embodiment should have the same direction of orthogonal attachment of the blades to their horizontal members. For a better view of this orthogonal attachment, please view FIG. 1B looking at the attachment of the blades 112A and 112C to the horizontal member 120A.

In FIG. 1A, the broad sides of the blades 112A are in a vertical position. The broad sides of the blades 112B (partially shown) are 45 degrees to the right, as depicted in the figure, from a vertical downward position. The broad sides of the blades 112C are in a horizontal position. The broad sides of the blades 112D are 45 degrees to the left, as depicted in the figure, from a vertical downward position. These positions of the coupled blades 112B and 112D at 45 degrees downward only exist for moments in time during the rotation of the embodiment.

When the embodiment 100 is being moved by a horizontal driving force, the vertical axis is rotating and the coupled blades are pivoting in response to the changes in the horizontal driving force. As the embodiment rotates, the direction of the driving force changes relative to the embodiment. The change of direction of the driving force changes the positioning of the coupled blades, since the blades respond to the driving force.

In this depiction, the blades 112B and 112D are in the vertical rotational position to be pivoting in response to the momentary drop in the force of the wind upon the blades and the force of gravity temporarily becomes the preeminent force upon the blades 112B and 112D. This change in force causes the blades 112D to pivot downward and the blades 112B to pivot upward simultaneously. The blades 112 pivot when their horizontal axes are nearly parallel to the direction of the horizontal driving force.

The blades 112A are receiving the full drag force of the wind upon the broad sides of their blades so the blades 112A and 112C are either ending their pivoting action or are no longer pivoting about the horizontal axis. The other blades 112B, 112C, and 112D have their broad sides parallel to the wind so there is much less wind force being exerted upon these blades than the blades 112A. With the full drag force of the wind upon the blades 112A and the other blades 112B, 112C, and 112D having little drag, the force of the wind is transmitted to the embodiment to cause a counterclockwise rotation of the embodiment when viewed from the top of the embodiment.

In FIG. 1A, the pivoting of some of the blades 112A is obstructed by the blades 112A that are just below them on the turbine. The pivoting of some of the blades 112B is obstructed by the blades 112B that are just below them on the turbine. The pivoting of some of the blades 112C is obstructed by the blades 112C that are just below them on the turbine. Some of the blades 112 are a pivot restriction means for the other blades 112 that are vertically above them.

The embodiment 100, as depicted in FIG. 1A, 1B, and 1C, has pivot stops (116A and 116B, collectively 116) to restrict the pivoting action of the coupled blades. The pivot stops 116 are a horizontally disposed member. The pivot stops 116 pass through the horizontal orifices of the rotary shaft 108. The middle portion of each pivot stop occupies the horizontal orifice of the rotary shaft 108.

The ends of the pivot stops extend horizontally from the rotary shaft 108 to restrict the pivoting action of the lowest blades that are vertically adjacent to the pivot stops. These pivot stops are a pivot restriction means. The pivot stop 116A obstructs the pivoting of the lowest blades 112A and 112C on the rotary shaft 108. The pivot stop 116B obstructs the pivoting of the lowest blades 112B and 112D.

In FIG. 1B, the same embodiment 100 at the same instance in time and having the same wind direction is depicted in an isometric downward right view. The description of the elements and how they function in the description of FIG. 1A apply to this description in FIG. 1B. This depiction allows the positioning of the blades 112 to be better seen. The wind is horizontal and parallel to the horizontal member 120B. The wind passes by the blades 112D and exits the embodiment past the blades 112B.

The generator housing 104 is shown at the base of the embodiment. The rotary shaft 108 is vertical and central. The horizontal members 120A and 120B are shown extending through the rotary shaft 108. The horizontal members 120A extend from the right foreground to the left background. The horizontal members 120B extend from the left foreground to the right background. The horizontal members 120 pivot within the orifices of the rotary shaft 108.

The broad side of the blades 112A is in a vertical downward position. The trailing portion of the blades 112A overlap slightly with the blades 112A that are vertically below them. This overlap of the blades allows less wind to escape the embodiment, thus increasing the total drag force acting across the vertically aligned blades. The force of the wind is pushing on the broad side of the blades 112A.

The broad side of the blades 112B is parallel to the wind, 45 degrees to the right of a vertical downward position, and the blades 112A are blocking most of the wind from pushing on the blades 112B. The strongest force upon the blades 112B is the force of gravity.

The broad side of the blades 112D is parallel to the wind, 45 degrees to the left of a vertical downward position, the blades 112D are being pushed very little by the wind, and the strongest force upon the blades 112D is the force of gravity. The blades 112D and 112B have attachment positions to the horizontal member 120B that are orthogonal to each other.

The broad sides of the blades 112C are horizontal. The blades 112C are coupled to the blades 112A. When the blades 112C are horizontal and parallel to the wind, the wind passes through the blades 112C and places only a very small amount of drag on the embodiment. The force of the wind pushing on the blades 112A is greater than the force being applied to the blades 112C, therefore there is a rotational force being applied to the rotary shaft 108. The rotary shaft 108 will rotate in a counter clockwise direction when the embodiment is viewed from the top.

The broad sides of the blades 112B and 112D are parallel to the wind. In this position, relative to the wind, the force of the wind upon the blades 112B and 112D is negligible for an instant. The force of gravity pulls the blades 112D downward into 45 degree downward position resulting in the simultaneous pivoting of the blades 112B upward into a 45 degree downward position.

In this 45 degree downward position, the embodiment continues to rotate about the vertical axis. As the embodiment rotates about the vertical axis, the force of the wind pushes the blades 112D and 112B causing the blade 112D to pivot downward, thus increasing the drag force upon this blade, and the blade 112B to pivot upward, thus decreasing the drag force upon this blade. With the greater drag force being applied to blade 112D, as opposed to the drag force upon 112B, the wind pushes the embodiment to rotate more about the vertical axis. The blade 112D eventually attains a vertical downward position and the blade 112B, simultaneously, attains a horizontal position.

The pivot stops 116 stop the nearest vertically adjacent blades from pivoting into an undesirable position. In FIG. 1B, the lowest blades 112A and 112C near the pivot stop 116A are stopped from pivoting and the lowest blades 112B and 112D near the pivot stops 116B are stopped from pivoting. The other blades 112 are stopped from pivoting by the adjacent blades 112 that are vertically below them.

In FIG. 1C, the same embodiment 100 at the same instance in time and having the same wind direction is depicted in a right side view. This depiction allows the positioning of the blades 112 to be seen from a different view. The wind is horizontal and parallel to the horizontal member 120B. The wind passes by the blades 112D and is exits the embodiment past the blades 112B.

The generator housing 104 is at the base of the embodiment. The rotary shaft 108 is vertical and central. The horizontal members 120A are shown from an end view. The horizontal members 120A extend through the orifices of the rotary shaft. The blades 112A and 112C are attached near the ends of the horizontal members 120A.

The horizontal members 120B extend laterally through the orifices of the rotary shaft 108. The blades 112B and 112D are attached near the ends of the horizontal members 120B. The blades 112B and 112D are depicted as shorter than the blades 112A as the blades 112B and 112D are at an angle relative to the blades 112A.

The blades 112B are pivoted toward the viewer, while the blades 112D are pivoted away from the viewer. This difference can be seen by comparing the lower trailing portions of the blades 112B and 112D. More of the beveled edge of the blades 112B can be seen than the beveled edge of the blades 112D. These blades 112 were designed with beveled edges, but they do not have to be.

The trailing portion of the lowest blade 112A is contacting the pivot stop 116A. The trailing portions of the other blades 112A are shown contacting the other blades 112A. These contacts between the blades prevent the wind from passing between the blades. The broad sides of the blades 112C are orthogonal to the broad sides of the blades 112A. As the blades 112 rotate with the embodiment around a vertical axis, the blades 112 will pivot to attain the various positions of the blades 112A, 112B, 112C, and 112D as depicted in the drawings.

In FIG. 1D, the same embodiment 100 at the same instance in time and having the same wind direction is depicted in a top view. The generator housing 104 can be seen at the base of the embodiment behind the other elements of the embodiment. The rotary shaft 108 is central and can be seen from an end view.

The horizontal member 120A is laterally depicted extending through the orifices of the rotary shaft 108. The horizontal member 120B is depicted vertically extending through the orifices of the rotary shaft 108. The blades 112 are attached to the ends of the horizontal members 120.

The edge of the front portion of the blade 112A can be seen on the right side of is the depiction. The broad side of blade 112C can be seen in a horizontal position on the left side of the depiction. The blade 112B can be seen above the rotary shaft 108, as depicted. The blade 112D can be seen below the rotary shaft, as depicted. The blades 112B and 112D appear to be shorter in width than the blade 112C, but this is due to the fact that the broad sides of the blades 112B and 112D are at a downward angle as compared to the blade 112C, which is at 90 degrees.

In FIG. 2, the embodiment 200 is depicted in an isometric downward right view. The embodiment 200 has a vertical axis; a generator connected to the vertical axis; one or more horizontal axes disposed along the vertical axis; one or more blades that are attached near each end of the horizontal axis wherein one or more blades are disposed on each side of the vertical axis, the blades are parallel to the horizontal axis, the blades are attached orthogonally relative to each other, and the blades pivot on a vertical path, wherein the blades coupled to a horizontal axis constitutes a coupled blade; a means for restricting the pivoting of the coupled blades; and a perimeter frame.

The embodiment 200 is similar to the embodiment 100. The embodiment 200 has a perimeter frame that is not present in the embodiment 100. The perimeter frame strengthens the embodiment.

The depiction in FIG. 2 is similar to the depiction in FIG. 1B. FIG. 2 is a depiction of embodiment 200 at a particular instance during the rotation of the embodiment about the vertical axis. The embodiment 200 is omni-directional and technically has no front or side.

Embodiment 200 has a generator housing 204 at the base of the embodiment. The generator housing 204 contains a generator (not shown) and any gears (not shown) needed for transferring a rotational force to the generator. The generator housing 204 is depicted as a broad structure to provide a solid base for the embodiment.

The rotary shaft 208 is a vertical and central shaft that rotates on a vertical axis. The rotary shaft 208 constitutes a vertical axis. The rotary shaft has several horizontal orifices that extend through the shaft. The horizontal orifices are either orthogonal or parallel to each other in this embodiment.

On the lower end of the rotary shaft 208 is a gear (not shown). The rotary shaft 208 is connected to the generator (not shown) within the generator housing 204 through a series of gears (not shown). The rotary shaft 208 drives the generator (not shown) within the generator housing.

The coupled blades (not individually labeled) are horizontally disposed along the vertical length of the rotary shaft 208. The coupled blades comprise a horizontal member (220A or 220B, collectively 220) and two blades (212A, 212B, 212C, or 212D, collectively 212). The horizontal member constitutes a horizontal axis.

The horizontal members 220A extend from the foreground right to the background left. The horizontal members 220B extend from the foreground left to the background right. The horizontal members 220 are disposed horizontally and occupy the horizontal orifices (not shown) of the rotary shaft 208.

The horizontal members 220 pivot on a horizontal axis within the horizontal orifices (not shown) of the rotary shaft 208. The horizontal members 220 have a middle portion and two ends. The middle portions of the horizontal members 220 occupy the horizontal orifices (not shown) of the rotary shaft 208.

The horizontal orifices of the rotary shaft 208 can be lined with a frictionless surface (not shown). The ends of the horizontal members 220 extend out from the rotary shaft 208. The horizontal members 220A pivot on a horizontal axis within the horizontal orifices of the rotary shaft.

The horizontal members 220A are parallel to each other. The horizontal members 220B are parallel to each other. The horizontal members 220B are orthogonally disposed relative to the horizontal members 220A.

The disposition of the horizontal members 220A and 220B alternate along the length of the rotary shaft 208. The horizontal members 220A are closer to the adjacent horizontal members 220B than to the adjacent horizontal members 220A. The horizontal members 220B are closer to the adjacent horizontal members 220A than to the adjacent horizontal members 220B.

Near each end of the horizontal member (220A or 220B) is a blade (212A, 212B, 212C, or 212D). The blades 212A and 212C are attached to horizontal members 220A. The blades 212B and 212D are attached to horizontal members 220B.

The blades 212 have a broad side and a narrow airfoil profile. The broad side of the blades 212 can be seen by looking at the blades 212A. The broad sides of the blades 212 are parallel with the length of the associated horizontal member and move on a vertical path.

The narrow airfoil profile of the blades 212 can be seen by looking at blades 212D. As depicted, the narrow airfoil profile is continuous along the entire length of the broad side.

The blades 212 have a front portion and a trailing portion. The front portions of the blades 212 are attached to the horizontal members 220 and the trailing portion pivots with the front portion. As shown, the blades 212 extend to partially overlap with the adjacent blades that are under them. This overlap is depicted by viewing the blades 212A, as the blades 212A are nearly vertical.

In this depiction, the blades 212A are disposed on the right side of the rotary shaft 208 in the foreground, the blades 212C are disposed on the left side of the rotary shaft 208 in the background, the blades 212D are disposed near the foreground on the left side of the rotary shaft 208, and the blades 212B (partially hidden) are disposed behind the rotary shaft.

The coupled blades pivot freely, as a unit. The blades 212A pivot simultaneously with the blades 212C, as these blades are coupled. The blades 212B pivot simultaneously with the blades 212D, as these blades are coupled. The blades 212A and 212C pivot independently of the blades 212B and 212D. The blades 212B and 212D pivot independently of the blades 212A and 212C.

The blades 212A and 212C are attached to the horizontal member 220A. The blades 212B and 212D are attached to the horizontal member 220B. The broad sides of the blades 212A and 212C are attached orthogonal to each other.

In FIG. 2, the blades 212B (partially visible) and the blades 212D are shown orthogonally attached to the horizontal member 220B (end view). For proper functioning, the coupled blades of an embodiment should have the same direction of orthogonal attachment of the blades to their horizontal members.

In FIG. 2, the broad sides of the blades 212A are in a vertical position. The broad sides of the blades 212B (partially shown) are 45 degrees to the right, as depicted in the figure, from a vertical downward position. The broad sides of the blades 212C are in a horizontal position. The broad sides of the blades 212D are 45 degrees to the left, as depicted in the figure, from a vertical downward position.

When the embodiment 200 is being moved by a horizontal driving force, the vertical axis is rotating and the coupled blades are pivoting in response to the changes in the horizontal driving force. As the embodiment rotates, the direction of the driving force changes relative to the embodiment. The change of direction of the driving force changes the positioning of the coupled blades, since the blades respond to the driving force.

The broad sides of the blades 212B and 212D are parallel to the wind. In this position, relative to the wind, the force of the wind upon the blades 112B and 112D is negligible for an instant. The force of gravity pulls the blades 212D downward into 45 degree downward position resulting in the simultaneous pivoting of the blades 212B upward into a 45 degree downward position.

In this 45 degree downward position, the embodiment continues to rotate about the vertical axis. As the embodiment rotates about the vertical axis, the force of the wind pushes the blades 212D and 212B causing the blade 212D to pivot downward, thus increasing the drag force upon this blade, and the blade 212B to pivot upward, thus decreasing the drag force upon this blade. With the greater drag force being applied to blade 212D, as opposed to the drag force upon 212B, the wind pushes the embodiment to rotate more about the vertical axis. The blade 212D eventually attains a vertical downward position and the blade 212B, eventually and simultaneously, attains a horizontal position.

As depicted in FIG. 2, the blades 212A are receiving the full drag force of the wind upon the broad sides of their blades so the blades 212A and 212C are either ending their pivoting action or are no longer pivoting about the horizontal axis. The other blades 212B, 212C, and 212D have their broad sides parallel to the wind so there is much less wind force being exerted upon these blades than the blades 212A. With the full drag force of the wind upon the blades 212A and the other blades 212B, 212C, and 212D having little drag, the force of the wind is transmitted to the embodiment to cause a counterclockwise rotation of the embodiment when viewed from the top of the embodiment.

In FIG. 2, the pivoting of some of the blades 212A is obstructed by the blades 212A that are just below them on the turbine. The pivoting of some of the blades 212B is obstructed by the blades 212B that are just below them on the turbine. The pivoting of some of the blades 212C is obstructed by the blades 212C that are just below them on the turbine. Some of the blades 212 are a pivot restriction means for the other blades 212 that are vertically above them.

The embodiment 200, as depicted in FIG. 2, has pivot stops (216A and 216B, collectively 216) to restrict the pivoting action of the coupled blades. The pivot stops 216 are a horizontally disposed member. The pivot stops 216 pass through the horizontal orifices of the rotary shaft 208. The middle portion of each pivot stop occupies the horizontal orifice of the rotary shaft 208.

The ends of the pivot stops extend horizontally from the rotary shaft 208 to restrict the pivoting action of the lowest blades that are vertically adjacent to the pivot stops. These pivot stops are a pivot restriction means. The pivot stop 216A obstructs the pivoting of the lowest blades 212A and 212C on the rotary shaft 208. The pivot stop 216B obstructs the pivoting of the lowest blades 212B and 212D.

The perimeter frame strengthens the embodiment 200. The perimeter frame consists of vertical members and upper members. The vertical members are 224A, 224B, 224C, and 224D, collectively 224. The upper members are 255A, 225B, 255C, and 255D, collectively 255.

The vertical members 224 have orifices that are orthogonal to the length of the member. The vertical members 224 are attached to the pivot stops 216 and extend vertically to the top of the embodiment. The ends of the horizontal members 220 occupy the orifices of the vertical members 224. The ends of the horizontal members 220 pivot freely within the orifices of the vertical members 224.

The upper member 255A is attached to the top end of the rotary shaft 208 and the top end of the vertical member 224A. The upper member 255B is attached to the top end of the rotary shaft 208 and the top end of the vertical member 224B. The upper member 255C is attached to the top end of the rotary shaft 208 and the top end of the vertical member 224C. The upper member 255D is attached to the top end of the rotary shaft 208 and the top end of the vertical member 224D.

The ends of the horizontal members 220A occupy the orifices of the vertical members 224A and the opposing ends of the horizontal members 220A occupy the orifices of the vertical members 224C. The ends of the horizontal members 220B occupy the orifices of the vertical members 224B and the opposing ends of the horizontal members 220B occupy the orifices of the vertical members 224D.

In FIG. 2, the wind is parallel with the horizontal members 220B and coming from the left side of the embodiment. This is how the embodiment would appear if the prevailing driving force came from the wind and the orthogonal attachment of the coupled blades were as depicted in the figure. The direction of the rotation of the embodiment 200 about the vertical axis would be counterclockwise when view from the top if the orthogonal attachment of the coupled blades were as depicted in the figure and the wind was parallel with the horizontal members 220B and coming from the left side of the embodiment.

In FIG. 3, the embodiment 300 is depicted in an isometric downward right view. The embodiment 300 has a vertical axis; a generator connected to the vertical axis; one or more horizontal axes disposed along the vertical axis; one or more blades that are attached near each end of the horizontal axis, wherein one or more blades are disposed on each side of the vertical axis, the blades are parallel to the horizontal axis, the blades on one end of the horizontal axis are attached orthogonally relative to the blades on the other end of the horizontal axis, and the blades pivot on a vertical path, wherein the blades coupled to a horizontal axis constitutes a coupled blade; a means for restricting the pivoting of the coupled blades; and a perimeter frame. The vertical axis of embodiment 300 is a rotary shaft 308 that is much shorter than the rotary shaft of the embodiments 100 and 200.

The embodiment 300 is similar to the embodiment 200. The rotary shaft 308 of embodiment 300 lacks horizontal orifices for the horizontal axes, and the horizontal axes of embodiment 300 do not extend through the rotary shaft 308.

FIG. 3 is a depiction of embodiment 300 at a particular instance during the rotation of the embodiment about the vertical axis. The embodiment 300 is omni-directional and has no front or side.

Embodiment 300 has a generator housing 304 at the base of the embodiment. The generator housing 304 contains a generator (not shown) and any gears (not shown) needed for transferring a rotational force to the generator. The generator housing 304 is depicted as a broad structure to provide a solid base for the embodiment.

The rotary shaft 308 is a vertical and central shaft that rotates on a vertical axis. On the lower end of the rotary shaft 308 is a gear (not shown). The rotary shaft 308 is connected to the generator (not shown) within the generator housing 304 through a series of gears (not shown). The rotary shaft 308 drives the generator (not shown) within the generator housing. The upper end of the rotary shaft 308 is connected to pivot stops 316A and 316B, collectively 316.

The pivot stops 316 are horizontally disposed members. The middle portion of the pivot stops 316 are connected to the upper end of the rotary shaft 308. The pivot stop 316B is orthogonally disposed relative to the disposition of the pivot stop 316A. The middle portion of the pivot stops 316 are connected to each other.

Attached to the ends of the pivot stops 316 are vertical members 324A, 324B, 324C, and 324D, collectively 324. The vertical member 324A is attached to the pivot stop 316A. The vertical member 324C is attached to the pivot stop 316A. The vertical member 324B is attached to the pivot stop 316B. The vertical member 324D is attached to the pivot stop 316B.

The vertical members 324 are disposed vertically. The vertical members 324 have horizontal orifices (not labeled) along the length of the vertical members. Attached to the upper end of the vertical members 324 are upper members 355A, 355B, 355C, and 355D, collectively 355. The upper members 355 are disposed horizontally above the horizontal axes of the embodiment.

One end of the upper member 355A is attached to vertical member 324A and the opposing end of the upper member is connected to the ends of the other upper members 355. One end of the upper member 355B is attached to vertical member 324B and the opposing end of the upper member is connected to the ends of the other upper members 355.

One end of the upper member 355C is attached to vertical member 324C and the opposing end of the upper member is connected to the ends of the other upper members 355. One end of the upper member 355D is attached to vertical member 324D and the opposing end of the upper member is connected to the ends of the other upper members 355. This attachment of the upper members 355 and vertical members 324 constitutes the perimeter frame (not labeled).

Horizontal members 320A and 320B, collectively 320, are horizontally disposed members that constitute the horizontal axes. The ends of the horizontal members 320 occupy the horizontal orifices (not labeled) of the vertical members 324. The horizontal members 324 pivot freely within the horizontal orifices of the vertical members 324. The vertical members 324 provide the structural support for the horizontal members 320.

The horizontal members 320A extend from the horizontal orifices of the vertical members 324A to the horizontal orifices of the vertical members 324C. The horizontal members 320B extend from the horizontal orifices of the vertical members 324B to the horizontal orifices of the vertical members 324D. The horizontal members 320 pivot on a horizontal axis.

The blades 312A, 312B, 312C, 312D, collectively 312, have a broad side and a narrow airfoil profile. The broad side of the blades 312 can be seen by looking at the blades 312A. The narrow airfoil profile of the blades 312 can be seen by looking at blades 312D. The narrow airfoil profile is continuous along the entire length of the broad side.

The blades 312 have a front portion and a trailing portion. The front portions of the blades 312 are attached to the horizontal members 320 and the trailing portion pivots with the front portion, wherein the broad side of the blades is parallel with horizontal axis and moves on a vertical path when the horizontal members pivot.

The blades 312A are attached near the ends of the horizontal members 320A and the blades 312C are attached near the opposing ends of the horizontal members 320A, wherein the broad side of the blades 312C is orthogonal to the broad side of the blades 312A. The blades 312B are attached near the ends of the horizontal members 320B and the blades 312D are attached near the opposing ends of the horizontal members 320B, wherein the broad side of the blades 312D is orthogonal to the broad side of the blades 312B.

One horizontal member, the attached blade at one end of the horizontal member, and the attached blade on the opposing end of the horizontal member constitute a coupled blade. This orthogonal attachment of the blades 312 to the horizontal members 320 is in the same direction for each of the coupled blades (not labeled). The coupled blades (not individually labeled) are horizontally disposed along the vertical length of the vertical axis (not labeled).

The horizontal members 320A extend from the foreground right to the background left. The horizontal members 320B extend from the foreground left to the background right. The horizontal members 320A are parallel to each other. The horizontal members 320B are parallel to each other. The horizontal members 320B are orthogonally disposed relative to the disposition of the horizontal members 320A.

The disposition of the horizontal members 320A and 320B alternate along the length of the vertical axis. The horizontal members 320A are closer to the adjacent horizontal members 320B than to the adjacent horizontal members 320A. The horizontal members 320B are closer to the adjacent horizontal members 320A than to the adjacent horizontal members 320B.

The blades 312 extend to partially overlap with the vertically adjacent blades. This overlap can be seen by viewing the blades 312A, as the blades 312A are nearly vertical.

The blades 312A are disposed on the right side of the vertical axis in the foreground, the blades 312C are disposed on the left side of the vertical axis in the background, the blades 312D are disposed near the foreground on the left side of the vertical axis, and the blades 312B are disposed on the right side of the vertical axis in the background.

The coupled blades pivot freely, as a unit. The blades 312A pivot simultaneously with the blades 312C, as these blades are coupled. The blades 312B pivot simultaneously with the blades 312D, as these blades are coupled. The blades 312A and 312C pivot independently of the blades 312B and 312D. The blades 312B and 312D pivot independently of the blades 312A and 312C.

In FIG. 3, the broad sides of the blades 312A are in a vertical position. The broad sides of the blades 312B (partially shown) are 45 degrees to the right, as depicted in the figure, from a vertical downward position. The broad sides of the blades 312C are in a horizontal position. The broad sides of the blades 312D are 45 degrees to the left, as depicted in the figure, from a vertical downward position.

When the embodiment 300 is being moved by a horizontal driving force, the vertical axis is rotating and the coupled blades are pivoting in response to the changes in the horizontal driving force. As the embodiment rotates, the direction of the driving force changes relative to the embodiment. The change of direction of the driving force changes the positioning of the coupled blades, since the blades respond to the driving force.

In this depiction, the blades 312B and 312D are in the vertical rotational position to be pivoting in response to the momentary drop in the force of the wind upon the blades and the force of gravity temporarily becomes the preeminent force upon the blades 312B and 312D. This change in force causes the blades 312D to pivot downward and the blades 312B to pivot upward simultaneously, as the blades are coupled. The blades 312 pivot when their horizontal axes are nearly parallel to the direction of the horizontal driving force.

The blades 312A are receiving the full drag force of the wind upon the broad sides of their blades so the blades 312A and 312C are either ending their pivoting action or are no longer pivoting about the horizontal axis. The other blades 312B, 312C, and 312D have their broad sides parallel to the wind so there is much less wind force being exerted upon these blades than the blades 312A. With the full drag force of the wind upon the blades 312A and the other blades 312B, 312C, and 312D having little drag, the force of the wind is transmitted to the embodiment to cause a counterclockwise rotation of the embodiment when viewed from the top of the embodiment.

In FIG. 3, the wind is parallel with the horizontal members 320B and coming from the left side of the embodiment. This is how the embodiment would appear if the prevailing driving force came from the wind and the orthogonal attachment of the coupled blades were as depicted in the figure. The direction of the rotation of the embodiment 300 about the vertical axis would be counterclockwise when view from the top if the orthogonal attachment of the coupled blades were as depicted in the figure and the wind was parallel with the horizontal members 320B and coming from the left side of the embodiment.

When the horizontal members are perpendicular to the direction of the wind, the coupled blades attached to those horizontal members are pivotably stationary about the horizontal axis, while the coupled blades are rotating around the vertical axis. When the horizontal members are nearly parallel to the direction of the wind, the coupled blades attached to these horizontal members are pivoting about the horizontal axis, while the coupled blades are rotating around the vertical axis.

The pivoting of the coupled blades about the horizontal axis occurs when the horizontal members of the coupled blades are nearly parallel with the direction of the wind, but not when the horizontal members of the coupled blades are orthogonal with the direction of the wind even though the embodiment is rotating around the vertical axis. This pivoting action positions the blades orthogonally to be pushed by the wind on one side of the vertical axis while the other blades are not orthogonal to the direction of the wind so the other blades have very little drag on the rotational motion of the vertical axis.

The coupled blades are pivotably connected to the vertical axis. The coupled blades may be attached to other structures that are connected to the vertical axis. This arrangement of the coupled blades would allow the middle portion of the horizontal axes to be away from the central vertical axis.

An additional feature that can be used with a wind turbine is a downdraft plate. The downdraft plate is a circular plate having a diameter approximately equal to the length of the coupled blades. The downdraft plate is installed horizontally on top of the turbine. The downdraft plate blocks downdrafts and helps focus the wind into the blades of the turbine.

Another desirable feature for adding to a turbine is solar cells. The solar cells can be added to any exposed surface of the turbine. The solar cells can be fastened to the blades of the turbine. The solar cells can be fastened to the generator housing of a turbine. Power generated by the solar cells can be collected when the turbine is capturing power from the wind. The power generated by the solar cells can be collected, even when the turbine is not capturing power from the wind.

The positive leads from the solar cells can be attached to the structure of the turbine. The negative leads from the solar cells can be connected to the downdraft plate, provided that the downdraft plate is electrically insulated from the remaining structure of the turbine. The power from the solar cells can be collected by contacting a lead to the downdraft plate and the opposite lead to the structure of the turbine.

Another desirable feature is a frictionless cylindrical sleeve. The frictionless cylindrical sleeve is made of a nearly frictionless material, such as a polymer of tetrafluoroethane. The frictionless cylindrical sleeve can be placed between the pivotable horizontal members and any structures that hold the horizontal members in place, such as the horizontal orifices of the rotary shaft. A nearly frictionless material could be placed in the horizontal orifices of the perimeter frame members to hold the ends of the pivotable horizontal members in place.

The invention may be used in other power generating applications, particularly wave power generation and tidal power generation. Moving water past the coupled blades of the invention would generate power. If the invention is used to generate power from water sources, it may be desirable to modify certain features of the invention to make it more suitable for an aquatic or marine environment, particularly changing the density of the blades to make them denser than water, use non-corrosive materials to construct the turbine, higher capacity generators, and different gear ratios.

The invention does not require all the advantageous features and all of the advantages to be incorporated into every embodiment of the invention. While the invention has been described with respect to a limited number of embodiments, those skilled in the art may appreciate numerous modifications and variations therefrom. Applicant intends to encompass within the language any structure presently existing or developed in the future that performs the same function. It is intended that the appended claims cover all such modifications and variations as fall within the true spirit and scope of the invention.

What is claimed is:

1. A turbine for generating power, the turbine comprising:
a vertical axis, and
a coupled blade, wherein the coupled blade comprises:
a horizontal axis, having a first end and a second end, pivotably connected to the vertical axis;
one or more blades, comprising a first set of blades, wherein the blades have a broad side and an airfoil profile, wherein the airfoil profile has a front portion and a trailing portion, wherein the front portion of the blades is attached to the first end of the horizontal axis, the broad side is parallel to the horizontal axis, and the trailing portion pivots on a vertical path; and
one or more blades, comprising a second set of blades, wherein the blades have a broad side and an airfoil profile, wherein the airfoil profile has a front portion and a trailing portion, wherein the front portion of the blades is attached to the second end of the horizontal axis, the broad side is parallel to the horizontal axis, and the trailing portion pivots on a vertical path, wherein the broad sides of the second set of blades is orthogonal to the broad sides of the first set of blades, wherein the first set of blades and the second set of blades pivot together when the horizontal axis pivots.

2. The turbine of claim 1, further comprising:
a means of restricting the pivoting action of the coupled blades.

3. The turbine of claim 1, further comprising:
a generator connected to the vertical axis, whereas the generator generates power when the vertical axis rotates.

4. The turbine of claim 1, further comprising:
one or more solar cells attached to the turbine.

5. The turbine of claim 2, further comprising:
two or more coupled blades.

6. The turbine of claim 5, wherein the horizontal axes of the coupled blades are parallel and aligned vertically.

7. The turbine of claim 6, further comprising:
a perimeter frame linking the ends of the horizontal axes of the coupled blades, wherein the horizontal axes are still capable of pivoting.

8. The turbine of claim 5, wherein the coupled blades are separated into two groups, a first group of coupled blades and a second group of coupled blades, wherein the first group of coupled blades has some of the horizontal axes of the coupled blades parallel to each other, the second group of coupled blades has some of the horizontal axes of the coupled blades of that group parallel to each other, and the second group of coupled blades is orthogonally disposed relative to the first group of coupled blades, wherein the horizontal axes of the first group of coupled blades are aligned vertically and the horizontal axes of the second group of coupled blades are aligned vertically.

9. The turbine of claim 8, wherein the horizontal axes of the two groups of coupled blades are alternately disposed, whereas any two adjacent horizontal axes of the same group of coupled blades have one horizontal axis of the other group of coupled blades between the two adjacent horizontal axes of the same group of coupled blades.

10. The turbine of claim 9, further comprising:
a generator connected to the vertical axis.

11. The turbine of claim 9, wherein the vertical axis is a vertically disposed rotary shaft.

12. The turbine of claim 11, further comprising:
four or more vertical members, wherein each vertical member is vertically disposed, wherein the ends of the horizontal axes that are parallel to each other and on the same side of the vertical axis are pivotably connected to a vertical member, wherein the rotary shaft does not extend upward past the horizontal axis of the lowest coupled blade, wherein the vertical members are connected to the rotary shaft.

13. The turbine of claim 11, further comprising:
four or more vertical members, wherein each vertical member is vertically disposed, wherein the ends of the horizontal axes that are parallel to each other and on the same side of the vertical axis are pivotably connected to a vertical member, wherein the vertical members are connected to the rotary shaft.

14. A kit for making a turbine, the kit comprising:
a rotary member, wherein the rotary member has a plurality of attachment sites along the length of the rotary member, wherein the rotary member is capable of rotating,
a plurality of pivotable members, having end portions and a middle portion, wherein the middle portion of the pivotable members are capable of being attached to the attachment sites of the rotary member, wherein the pivotable members are capable of pivoting on an axis that is central to and parallel with the length of the pivotable members when the pivotable members are attached to the rotary member, wherein the pivotable members are capable of rotating about an axis that is parallel to the length of the rotary member when the pivotable members are attached to the rotary member and the rotary member rotates, wherein the pivotable members are capable of accepting blade attachments at each end of the pivotable members, and
a plurality of blades, comprising a first set of blades and a second set of blades, wherein the blades have a broad side and an airfoil profile, wherein the blades have a front portion and a trailing portion along the airfoil profile, wherein the front portion of the blades are capable of being attached near the ends of the pivotable members, the broad side of the blades are parallel to the pivotable members, and the trailing portion of the blades move on a vertical path, wherein the first set of blades are capable of being attached to one end of the pivotable members and the second set of blades are capable of being attached to the opposing end of the pivotable members, wherein the broad sides of the second set of blades are capable of being attached orthogonal to the broad sides of the first set of blades when the blades are attached to the pivotable members.

15. The kit of claim 14, further comprising:
One or more solar cells.

16. A wind turbine, the turbine comprising:
an axis,
one or more blades connected to the axis,
one or more solar cells attached to the turbine, and
a generator connected to the axis.

17. The turbine of claim 16, wherein the solar cells are attached to the blades.

18. The turbine of claim 16, wherein the solar cells are attached to the supporting structure of the turbine.

19. The turbine of claim 16, wherein the solar cells are attached to the housing around the generator.

20. The turbine of claim 16, wherein the solar cells are attached to the steering mechanism of the turbine.
